(19) United States
(12) Patent Application Publication
(10) Pub. No.: US 2017/0088404 A1
(43) Pub. Date: Mar. 30, 2017

(54) VEHICLE LIFT

(71) Applicants: Marta Fiorese, Albignasego (PD) (IT); Sara Fiorese, Albignasego (PD) (IT)

(72) Inventors: Marta Fiorese, Albignasego (PD) (IT); Sara Fiorese, Albignasego (PD) (IT); Francesco Fiorese, Albignasego (PD) (IT)

(73) Assignees: Marta Fiorese, Albignasego (PD) (IT); Sara Fiorese, Albignasego (PD) (IT)

(21) Appl. No.: 15/311,936

(22) PCT Filed: May 20, 2015
(86) PCT No.: PCT/EP2015/061154

§ 371 Date: Nov. 17, 2016

(30) Foreign Application Priority Data
May 22, 2014 (IT) VI2014A000135

(51) Int. Cl. B66F 7/08; B66F 7/06

(52) U.S. Cl. CPC B66F 7/08; B66F 7/065

(57) ABSTRACT

There is provided a vehicle lift which includes, under the support plate (1) of the vehicle a lifting/lowering mechanism (101) having at least two pairs of levers articulated to one another in an intermediate section, which constitute the two forks, moved by at least one fluid-dynamic actuator (9). The fluid-dynamic actuator (9) acts on an articulated system (10), which supports at least one first roller (20) and at least one second roller (21) arranged on respective axes. The two rollers (20, 21), in the initial step of lifting/opening the fork, are kinematically coupled with two corresponding inclined surfaces.

The present finding concerns a vehicle lift, according to the general part of claim 1.

As well known, among the various types of lifts, used in body shops and in garages to allow the worker to work on the lower part of a vehicle, so-called fork or similar type systems are commonly used.

Such a lifting group comprises, at the two sides of the support plane of the vehicle, a fork-type lifting/lowering mechanism, consisting of two pairs of levers articulated to one another at an intermediate section thereof and where the lever of each of the two pairs, the one arranged most externally, has the lower end hinged on the base plate, resting on the ground and the upper end sliding beneath the support plane for supporting the vehicle, with longitudinal direction, while, contrarily, the other two levers, those arranged most externally, have the lower end sliding on the aforementioned base plate and the upper end sliding beneath the aforementioned upper support plane for lifting the vehicle.

The two pairs of levers that constitute the two forks are moved by at least one fluid-dynamic actuator, having one end articulated on the cross member that connects the two lower ends of the two outermost levers and the other end articulated, through an intermediate bracket, to the two upper arms of the two innermost levers.

Usually, these lifts, due to the particular structure of the frame (fork plus support plane) and of the lifting mechanisms used, when they are completely closed, have a bulk in height that is acceptable for the majority of vehicles whereas, on the other hand, due to such bulk, they cannot be used for all cars, in particular sports and racing cars, in which the space between the bottom of the vehicle and the ground is very small.

In so-called “low profile” lifts, i.e. in lifts that have a limited bulk in height when they are completely “packed up”, the difficulties mainly occur in the first lifting step, when the fluid-dynamic actuator has to develop the force (initial pickup) necessary to lift the load.

The value of such a force, as the lifting proceeds, decreases thanks to the increasing inclination of the cylinders so that, in practice, a great force (thrust) of the cylinders is only necessary in the first section of the upward stroke of the lift. In fact, substantial bulks in height and/or in width are in any case necessary in order to be able to install cylinders with sufficient dimensions in order to obtain the force necessary for lifting in the first part of the upward stroke, obviously using up material and energy.

Another limitation concerning fork-type lifts or similar consists of the fact that the structure must be limited in terms of the extension in width, in order to be able to be contained within the inner width of the wheels of the vehicle; moreover, the thrust mechanisms must not project from the upper plane since, frequently, sports and racing cars are lifted with the bottom, that rests directly on the plane of the lift.

The purpose of the present finding is to make a fork-type lift of the type described above, which does not have the drawbacks displayed by similar known products.

Specifically, the purpose of the finding is to make a fork-type lift that, as well as having a minimum bulk in height that is smaller than that of lifts found on the market, also associated the properties of requiring, at the start of lifting, a thrust force of the jacks of substantially lower value than the thrust force required by common lifts.

A further purpose is to make a fork-type lift or similar, which has a simplified and light structure, with the elements that constitute the lifting mechanism, in particular the levers, the pins and the components of the oil-hydraulic circuit, of reduced dimensions; at the same time it must be suitably strong, so that the mechanical safety system, applied to the structure, allows workers to work beneath the lifted vehicle in optimal conditions.

Such purposes are achieved by inserting, between the fluid-dynamic actuator and the lifting mechanism consisting of the fork levers, an articulated system consisting of two connecting rods and a rocker arm, where the two mutually opposite side walls of the rocker arm, hinged between the two innermost levers, support at least one first roller, hinged with rotary coupling on a first pin, which joins the upper end of the fluid-dynamic actuator with the rocker arm, said first roller working in kinematic coupling with a first surface that is variable from a horizontal position to an inclined position with respect to the ground and at least one second roller, hinged with rotary coupling on a second pin, positioned on the opposite side on said rocker arm. Such a second roller works in kinematic coupling with a second surface, variable from a horizontal position to an inclined position with respect to the ground.

Operatively, when the lift is completely closed and packed, the fluid-dynamic actuator and the articulated system are aligned with each other on the same horizontal axis so that, being able to use oil-hydraulic cylinders of reduced dimensions, it is possible to reduce to the minimum the bulk in height of the lift, i.e. the distance between the base plate, resting on the floor, and the upper lifting plane, where the vehicle rests.

Thereafter, through the effect of the kinematic coupling described above, the fork mechanism moves, carrying out a greater vertical stroke than the trajectory travelled by the rollers on the respective inclined surfaces, with the practical result of requiring a lower thrust force, the so-called “pickup”, of the fluid-dynamic actuator, in the first lifting step, such as to be almost equal to the value of the force required by the aforementioned actuator when the lift is almost completely lifted.

Further advantages and characteristics of the finding will become clearer from the description of a possible embodiment thereof, given only as a non-limiting example, with the help of the attached tables of drawings, where:

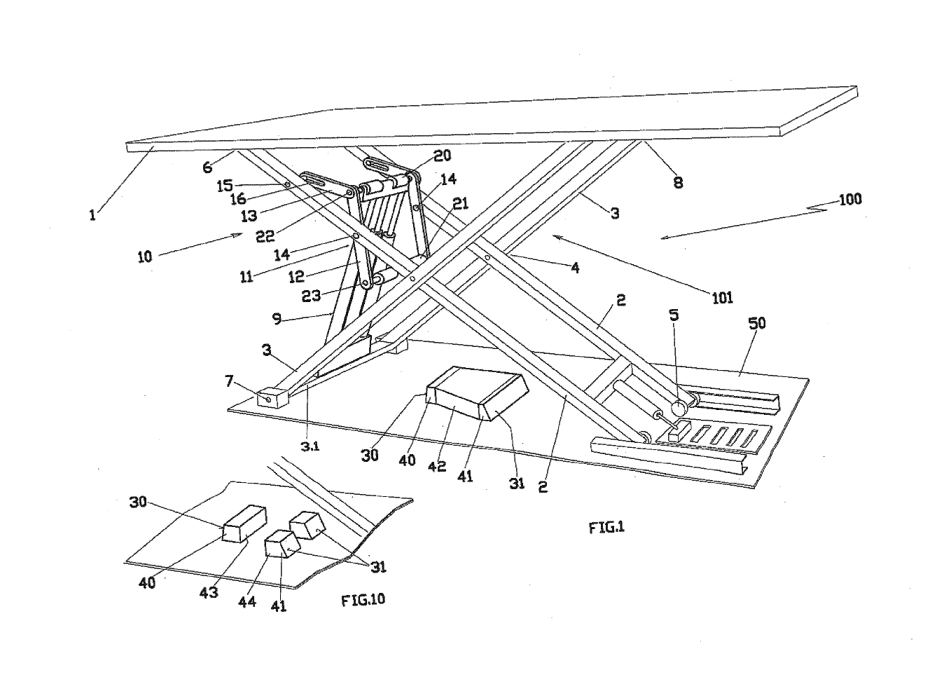

FIG. 1 represents a perspective view of the lift according to the finding, in open condition;

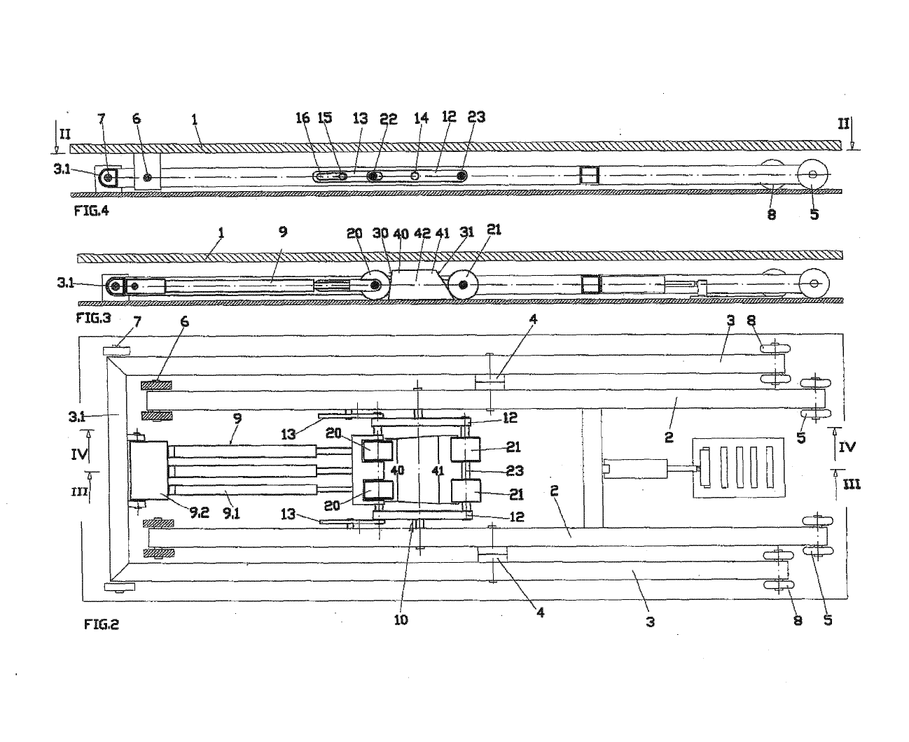

FIGS. 2, 3 and 4 represent section views of the lift according to FIG. 1, in completely closed condition; FIG. 2 is a plan view sectioned according to the line II-II of FIG. 4, whereas FIGS. 3 and 4 are elevated views, respectively sectioned according to the lines III-III and IV-IV of FIG. 2;

FIG. 5 represents a perspective view of the articulated system, in completely closed condition of the lift, with the position of the rollers on the respective inclined surfaces;

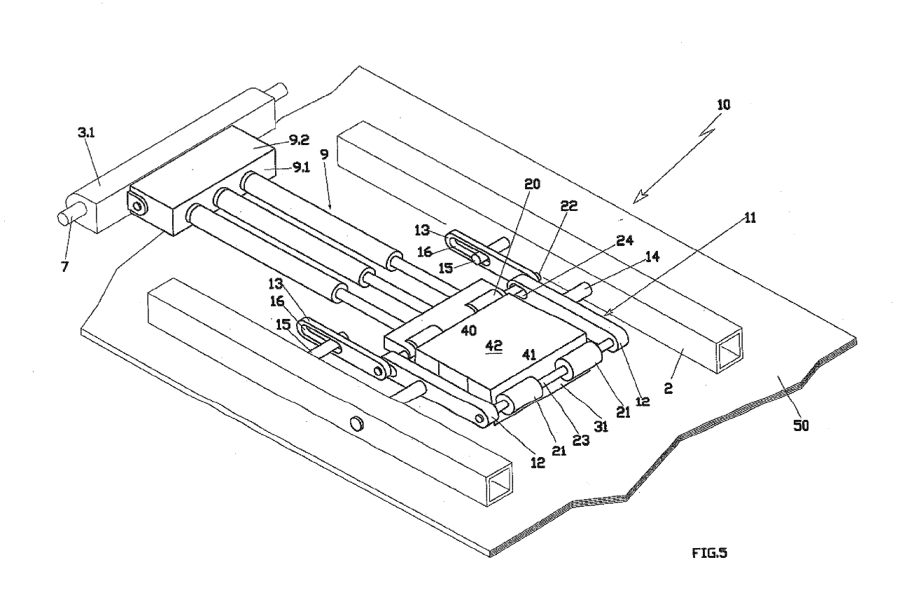

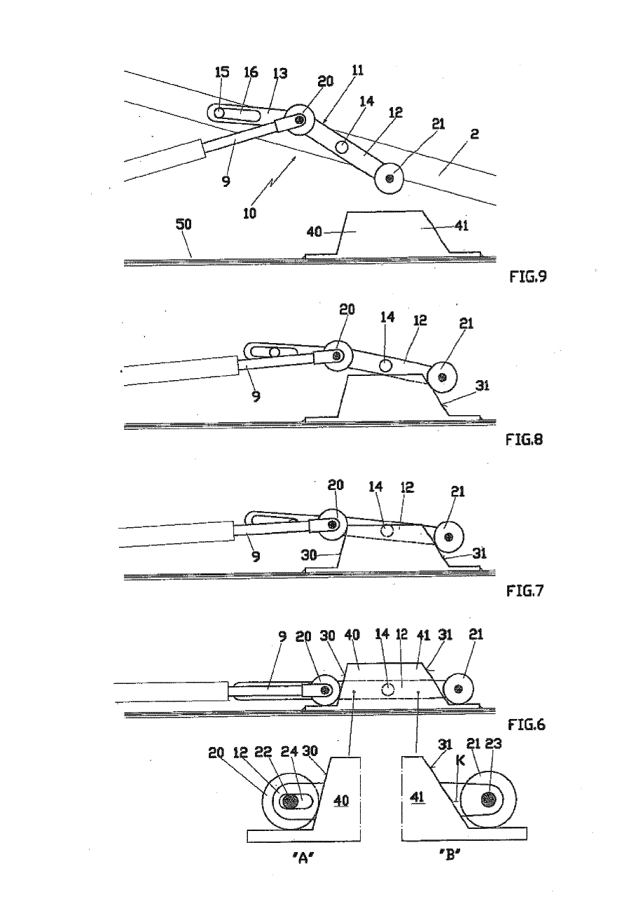

FIGS. 6 and 7 represent the operation of the articulated rocker arm/pair of connecting rods group and the position of the rollers with respect to the respective surfaces, during the initial lifting steps;

FIGS. 8 and 9 represent the operation of the articulated rocker arm/pair of connecting rods group and the position of the rollers with respect to the respective surfaces, during the steps after the initial lifting ones.

FIG. 10 represents a detailed view of a variant of FIG. 1.

In FIGS. 1-3 it is possible to see a vehicle lift according to the finding, indicated with reference numeral 100, where the lifting/lowering movement of the upper support plane 1 is obtained by a moving group 101, which comprises, at each of the two longitudinal sides of said support plane 1, two pairs of levers 2 and 3, articulated to each other at an intermediate section 4; the two parallel levers 2, arranged most internally, are equipped at the lower end with wheels 5 able to slide at the ground level, along a trajectory concordant with the longitudinal axis of the plane 1 and the upper end hinged with a first pin 6 below the plane 1, whereas the two levers 3, arranged most externally, have the lower end hinged with the second pin 7 to the base 50, resting on the ground and the upper end equipped with wheels 8, able to slide below the plane 1.

The entire lifting mechanism is actuated by a fluid-dynamic actuator, wholly indicated with reference numeral 9, which has the lower end articulated on a cross member 3.1, which connects the two outermost levers 3, whereas the upper end acts on an articulated system, wholly indicated with reference numeral 10, to give a synchronous movement to the two lateral scissors.

The articulated system 10, which connects to the two innermost levers 2, consists of a rocker arm, wholly indicated with reference numeral 11 and two connecting rods 13, where each of the two side walls 12 of the rocker arm 11 is hinged on a corresponding intermediate axis 14, whereas the connecting rods 13 are held by two projecting pins 15, on which the corresponding slits 16 slide, which are formed on said corresponding connecting rods 13.

Moreover, the rocker arm 11 supports, at the two opposite ends, at least two rollers 20 and 21, which, in the first lifting step (opening of the fork) of the lift, move in kinematic contact with at least two corresponding inclined surfaces 30 and 31, formed on two opposite portions 40 and 41 of a single block 42, or made on two opposite portions 40 and 41 of two or more separate blocks 43 and 44.

In particular, as can be seen in FIG. 3, the portions of the two surfaces 30 and 31, which are in kinematic contact with the corresponding rollers 20 and 21, are inclined a mutually convergent manner (in the illustrated example, upwards) and have the same or different inclination to each other and a shape suitable for optimising the thrust of the fluid-dynamic actuator 9.

Constructively, as can be seen in particular in FIG. 5, the opposite rollers 20 and 21 are hinged on the pins 22 and 23 and the front pin 22 has a dual function: that of articulating the rocker arm 11/connecting rod 13 pair and that of fastening the upper part of the fluid-dynamic actuator 9, which transmits the force to the articulated system 10.

Operatively, as can be seen in the sequence of FIG. 6 and thereafter, with the constructive solution according to the finding, in the initial lifting step, it is foreseen for the two opposite rollers 20 and 21, supported by the rocker arm 11, which angularly rotates on the intermediate axis 14 when, through the effect of the thrust of the fluid-dynamic actuator 9, said rocker arm gradually lifts in combination with the opening of the fork, which move, in the first fraction of stroke, both in contact with the respective inclined surfaces 30 and 31 (FIG. 7); thereafter, only the second roller 21 (FIG. 8) remains in contact and, thereafter again, the roller 21 also completely moves away from the corresponding surface 31 (FIG. 9) and the lift continues the upward stroke.

In practice, laboratory tests and practical garage tests have confirmed that, through the effect of the balancing of the opposing forces that act at the contact point of the rollers 20 and 21 on the corresponding blocks 42 or 43 and 44, the thrust force, or “pickup”, required of the actuator 9 in the initial upward step is substantially less than the initial thrust force required of the actuator mounted on normal lifts.

In a second embodiment, as can be seen in the details “A-B” of FIG. 6, when the lift is totally closed (horizontal axis) the roller 21 is slightly distanced (K) from the corresponding surface 31 so that, in the initial lifting step, only the front roller 20 rests on the relative surface 30 and, only thereafter, the aforementioned second roller 21 also goes back to rest; thereafter, in the upward step, the roller 21 also moves away from the respective surface 31.

The finding also foresees, as can be seen in FIG. 5 and in the detail of FIG. 6, that the front pin 22, hinged to the two side walls 12 of the rocker arm 11, is engaged inside two grooves 24, which allows the aforementioned pin 22, in the initial operating step, to travel a short stroke inside the grooves 24, during the contact of the roller 20 with the inclined surface 30.

Constructively, the fluid-dynamic actuator 9 is made up of a plurality of jacks 9.1, screwed to a single supply block 9.2, which acts as hinging means of the entire group 9 to the cross member 3.1.

In practice, a further embodiment operating according to the ways described above, foresees that the two inclined surfaces 30 and 31 are applied below the plane 1.

Similarly, another embodiment, again operating according to the ways described above foresees that the two inclined surfaces 30 and 31 are applied on the levers 2 and 3 of the fork mechanism.

Again in practice, the articulated system 10 and the inclined surfaces 30 and 31, can be applied, as well as to vehicle lifts with single and double fork, also to lifts with lifting/lowering mechanism consisting of at least two pairs of articulated levers, for any use and with a support device consisting of a single platform, two platforms, multiple platforms or with different forms of load supports.

Moreover, the rollers 20 and 21 can be replaced with sliding blocks which move in contact with the corresponding shaped surfaces 30 and 31.

The present finding can undergo modifications and variants and its technical details can be replaced with other technically equivalent elements; moreover, the materials and sizes can be various, according to requirements, provided that it is encompassed by the inventive concept defined by the following claims.

1-12. (canceled)

13. A vehicle lift which includes, under a support plane (1) of a vehicle, a lilting/lowering mechanism (101), consisting of at least two pairs of levers (2, 3), articulated to one another in an intermediate section, which constitute the two forks, moved by at least one fluid-dynamic actuator (9) which acts on a rocker arm (11) of an articulated system (10), wherein said rocker arm (11) supports at least one first roller (20) and at least one second roller (21), arranged on respective external axes with respect to an intermediate rotation axis (14) of said rocker arm (11), said articulated system (10) consisting of said rocker arm (11) having two side walls (12) hinged to two inner levers (2), each on said corresponding intermediate axis (14), said vehicle lift further comprising, in an initial lifting step, the first and second rollers (20, 21) being supported by the rocker arm (11), which, being able to rotate angularly on the intermediate axis (14), through the effect of the thrust of the fluid-dynamic actuator (9), gradually lifts in combination with the opening of the fork, whereas said first and second rollers (20, 21) move in contact with respective inclined surfaces (30, 31); thereafter, the first roller (20) moves away from its respective inclined surface (30) while the second roller (21) remains in contact with its respective inclined surface (31) and, thereafter the roller (21) moves away from its respective inclined surface (31).

14. The vehicle lift according to claim 13, wherein in the initial lifting step, the first and second rollers (20, 21) are supported by the rocker arm (11) which, being able to rotate angularly on the intermediate axis (14), through the effect of the thrust of the fluid-dynamic actuator (9), gradually lifts in combination with the opening of the fork, whereas said first and second rollers (20, 21) move in contact with their respective inclined surfaces (30, 31) by means of grooves (24), obtained on the rocker arm (11), which allow the first roller (20), hinged on a pin (22), to hingedly rotate on its respective inclined surface (30), still through the effect of the thrust of the fluid-dynamic actuator (9) on the rocker arm (11) by means of the pin (22), moving inside the grooves (24), thus allowing the second roller (21) to rotate resting on its respective inclined surface (31); in a later second step, the pin (22) completes its stroke inside the grooves (24), whereas both first and second rollers (20, 21) remain in contact with their respective inclined surfaces (30, 31); in a later third step, still through the effect of the thrust of the fluid-dynamic actuator (9) on the rocker arm (11) by means of the pin (22), the first roller (20) detaches from its respective inclined surface (30), whereas the second roller (21) remains in contact with its respective inclined surface (31); in the following lifting steps, the second roller (21) detaches from its respective inclined surface (31) and, by means of a pair of connecting rods (13) hinged at the end of the pin (22) and held by two projecting pins (15), on which corresponding slots (16), obtained on said corresponding connecting rods (13) develop, the ascent stroke of the lift is completed.

15. The vehicle lift according to claim 14, wherein, due to a distance separating the intermediate axis (14) of rocker arm (11) and the axis (23) of the second roller (21) and/or a distance separating the inclined surface (30) of the first roller (20) and the inclined surface (31) of the second roller (21), in the initial lifting step only the first roller (20) rotates in contact with its respective inclined surface (30), whereas the second roller (21) does not rest against its respective inclined surface (31), and in the following lifting step also the second roller (21) is in contact with its respective inclined surface (31); successively, in the proceeding of the lifting step, the first roller (20) detaches and separates from its respective inclined surface (30), whereas the second roller (21) remains in contact with its respective inclined surface (31) until, in the proceeding of the lifting step, said second roller (21) detaches and separates from its respective inclined surface (31).

16. The vehicle lift according to claim 14, wherein due to a distance separating the intermediate axis (14) of rocker arm (11) and the axis (23) of the second roller (21) and/or a distance separating the inclined surface (30) of the first roller (20) and the inclined surface (31) of the second roller (21), the first roller (20) rotates in contact with its corresponding inclined surface (30), whereas the second roller (21) does not rest against its respective inclined surface (31), and in the following lifting step the first roller (20) detaches from its respective inclined surface (30), whereas the second roller (21) remains detached from its respective inclined surface (31); later, the second roller (21) is in contact with its respective inclined surface (31); successively, in the proceeding of the lifting step, the first roller (20) separates from its respective inclined surface (30), whereas the second roller (21) remains in contact with its respective inclined surface (31), until later said second roller (21) detaches and separates from its respective inclined surface (31).

17. The vehicle lift according to claim 14, wherein the pin (22) of the first roller (20) is hinged inside two corresponding grooves (24) formed on the rocker arm (11), this allows the aforementioned pin (22), in the initial lifting step, to travel a short stroke inside said grooves (24), during the contact of the first roller (20) with its respective inclined surface (30).

18. The vehicle lift according to claim 13, wherein the respective inclined surfaces (30, 31) are arranged opposite, convergent and with mutually identical inclination with respect to a horizontal plane of a base (50).

19. The vehicle lift according to claim 13, wherein the respective inclined surfaces (30, 31) are arranged opposite, convergent and with mutually different inclinations with respect to a horizontal plane of a base (50).

20. The vehicle lift according to claim 13, wherein the respective inclined surfaces (30, 31), where the respective first and second rollers (20, 21) move, extend rectilinearly or are shaped according to a profile that goes from horizontal to inclined with respect to a horizontal plane and said shape, suitable for optimizing the thrust of the fluid-dynamic actuator (9), is the same in both of said inclined surfaces (30, 31).

21. The vehicle lift according to claim 13, wherein the respective inclined surfaces (30, 31), where the respective first and second rollers (20, 21) move, extend rectilinearly or are shaped according to a profile that goes from horizontal to inclined with respect to a horizontal plane and said shape, suitable for optimizing the thrust of the fluid-dynamic actuator (9), is mutually different in said inclined surfaces (30, 31).

22. The vehicle lift according to claim 13, wherein the respective inclined surfaces (30, 31) are formed on two opposite portions (40, 41) of a single block (42).

23. The vehicle lift according to claim 13, wherein the respective inclined surfaces (30, 31) are formed on two opposite portions (40, 41) of two or more separate and opposite blocks (43, 44).

24. The vehicle lift according to claim 13, wherein the elements that make contact with the inclined surfaces (30, 31) consist of sliding blocks.
